(19) United States
(12) Patent Application Publication
(10) Pub. No.: US 2025/0173657 A1
(43) Pub. Date: May 29, 2025

(54) OPERATION PROCESS SEARCH DEVICE, OPERATION PROCESS SEARCH METHOD, AND OPERATION PROCESS SEARCH PROGRAM

(71) Applicant: Hitachi Solutions, Ltd., Tokyo (JP)

(72) Inventors: Ryo SOGA, Tokyo (JP); Daisuke FUKUI, Tokyo (JP); Masayoshi MASE, Tokyo (JP); Naoya ISHIDA, Tokyo (JP); Masahiko INOUE, Tokyo (JP)

(21) Appl. No.: 18/843,639

(22) PCT Filed: Feb. 6, 2023
(86) PCT No.: PCT/JP2023/003810

§ 371 Date: Sep. 3, 2024

(30) Foreign Application Priority Data
Jul. 20, 2022 (JP) 2022-115602

(51) Int. Cl. G06Q 10/0635; G06Q 10/0639

(52) U.S. Cl. CPC G06Q 10/0635; G06Q 10/0639

(57) ABSTRACT

An operation process using AI can be configured after evaluating a risk of inference incorrectness occurring in the AI. A risk evaluation unit 20 calculates, for each route leading to a conclusion that is to be taken by an operation process candidate, a risk score based on an occurrence probability of the route and a disadvantage score calculated based on a negative influence evaluation value of influence generated in the route, and calculates, as a risk score of the operation process candidate, a sum of the risk scores calculated for a plurality of the routes that is to be taken by the operation process candidate. A display unit 12 displays, to a user, step flows of a plurality of the operation process candidates and the risk scores of the operation process candidates calculated by the risk evaluation unit.

### TECHNICAL FIELD

The present invention relates to an operation process search device, an operation process search method, and an operation process search program.

### BACKGROUND ART

PTL 1 discloses an operation process evaluation method. A performance of an operation process is monitored, and when degradation in the performance is observed, it is identified whether the degradation is caused by an external factor or an internal factor, and the degradation in the performance caused by the internal factor is extracted as an improvement target.

In recent years, there is a motion of introducing artificial intelligence (AI) into an operation process. By introducing the AI to the operation process, it is possible to improve a performance of the operation process remarkably.

### CITATION LIST

### Patent Literature

PTL 1: JP2018-5550A

### SUMMARY OF INVENTION

### Technical Problem

While the introduction of the AI to the operation process improves the performance of the operation process, depending on a content of the operation process, an AI-based inference result may cause a psychological, economic, or physical disadvantage to an organization or a person. A case in which AI is applied to a task allocation operation is taken as an example. For example, introduction of an operation process is considered in which the AI determines a skill of a candidate based on a PR video submitted by the candidate, and assigns a candidate determined to have an appropriate skill to a task. At this time, when incorrectness occurs in an AI-based inference result on the skill of the candidate, as a result, a candidate whose skill level is insufficient may be assigned or a candidate whose skill level is sufficient may not be assigned. In this case, even when the performance of the task allocation operation to which the AI is introduced is improved, it is difficult to say that an original purpose of the task allocation operation is achieved.

Therefore, when the AI is introduced to the operation process, it is necessary not only to determine an acceptability using the performance as shown in PTL 1 as an indicator, but also to configure the operation process using the AI after evaluating a risk of inference incorrectness occurring in the AI. Further, depending on the content of the operation process, a risk evaluation from a viewpoint of AI logic is also important. For example, in the above example, even when the AI correctly determines a skill level, an inference is not appropriate if a deviation occurs in a race or a gender in the inference result. Even when an AI-based inference is taken into the operation process, it is desirable to be able to explain to a person or an organization influenced by the inference that the operation process is configured in a convincing manner that reflects an original purpose of the operation process.

### Solution to Problem

An o operation process search device according to an embodiment of the invention is an operation process search device including: a memory; and a processor configured to function as a functional unit by executing a program loaded in the memory, in which
an input unit, a risk evaluation unit, and a display unit are provided as the functional unit,
the input unit receives an input of data of a plurality of operation process candidates from a user and stores the data in a data storage unit, and the data of the operation process candidates includes a step flow including a step of performing an inference by artificial intelligence, an influence evaluation table in which influence of a conclusion of an operation process, which is a content of a final step of the operation process candidate, on a related person and an influence evaluation value are registered, and a transition probability table in which a transition probability of a branch included in the step flow is registered,
the risk evaluation unit calculates, for each route leading to a conclusion that is to be taken by the operation process candidate, a risk score based on an occurrence probability of the route and a disadvantage score that is calculated based on a negative value of the influence evaluation value of the influence generated in the route, and calculates, as a risk score of the operation process candidate, a sum of the risk scores calculated for a plurality of the routes that is to be taken by the operation process candidate, and
the display unit displays, to the user, the step flows of the plurality of operation process candidates and the risk scores of the operation process candidates calculated by the risk evaluation unit.

### Advantageous Effects of Invention

It is possible to configure the operation process using the AI after evaluating a risk of inference incorrectness occurring in the AI. Other problems and novel features will become apparent based on description of the present specification and the accompanying drawings.

### BRIEF DESCRIPTION OF DRAWINGS

FIG. 1 is a functional block diagram of an operation process search device according to Embodiment 1.

FIG. 2 is a hardware structure example of an information processing device.

FIG. 3 is an example of operation process candidates.

FIG. 4 is an example of an influence evaluation table.

FIG. 5 is an example of a transition probability table.

FIG. 6 is a diagram showing a risk score calculation method.

FIG. 7 is a diagram showing a risk score calculation process.

FIG. 8 is an example of an operation process candidate evaluation screen.

FIG. 9 operation process before introduction of AI.

FIG. 10 is an example of a change list.

FIG. 11 is an example of an ease evaluation list.

FIG. 12 is a functional block diagram of an operation process search device according to Embodiment 2.

FIG. 13 is an example of a checking ratio list.

FIG. 14 is an example of a sensitive attribute table.

FIG. 15 is a diagram showing a checking cost calculation process.

FIG. 16 is an example of an evaluation result list.

FIG. 17 is an example of an execution cost list.

FIG. 18 is a diagram showing an execution cost calculation process.

FIG. 19 is an example of an evaluation result list.

### DESCRIPTION OF EMBODIMENTS

Hereinafter, embodiments of the invention will be described with reference to the drawings.

### Embodiment 1

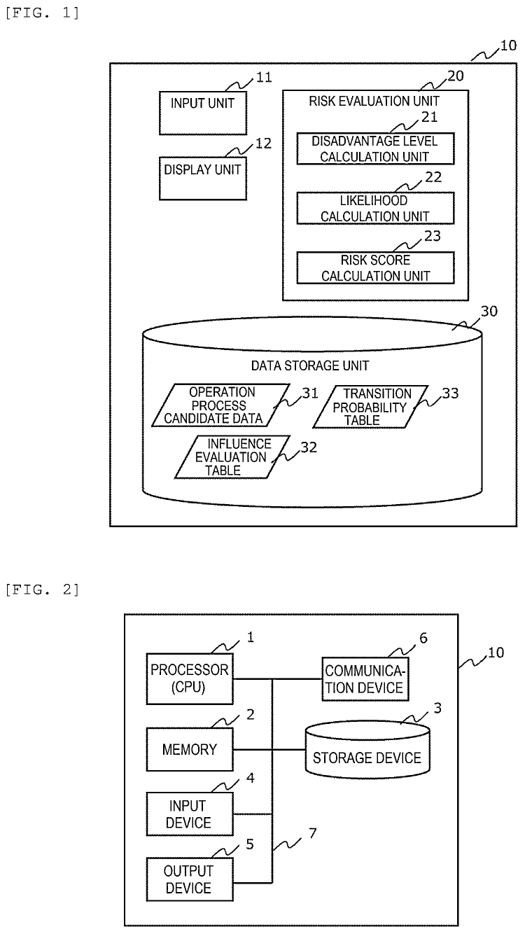

FIG. 1 is a functional block diagram of an operation process search device 10 according to Embodiment 1. FIG. 2 shows a hardware structure of the operation process search device 10. The operation process search device 10 is implemented by an information processing device including a processor (CPU) 1, a memory 2, a storage device 3, an input device 4, an output device 5, a communication device 6, and a bus 7 as main components as shown in FIG. 2. The processor 1 functions as a functional unit that provides a predetermined function by executing processing according to a program loaded in the memory 2. The storage device 3 stores data and a program used by the functional unit. As the storage device 3, for example, a nonvolatile storage medium such as a hard disk drive (HDD) or a solid state drive (SSD) is used. The input device 4 is a keyboard, a pointing device, and the like. The output device 5 is a display and the like. The communication device 6 can communicate with another information processing device via a network. These components are communicably connected via the bus 7.

The operation process search device 10 is not necessarily implemented by one information processing device, and may be implemented by a plurality of information processing devices. A part or all of functions of the operation process search device 10 may be implemented as a cloud-based application.

The operation process search device 10 is a device implemented by the information processing device executing an operation process search program, and includes functional units of an input unit 11, a display unit 12, and a risk evaluation unit 20. The operation process search device 10 will be described taking, as an example, an operation process configuration in which AI is applied to a task allocation operation.

The input unit 11 is a functional unit that receives, from a user, an input of information regarding an operation process to be configured and stores the information in a data storage unit 30. The input operation process information includes operation process candidate data 31 indicating a content of an operation process candidate examined by the user regarding the operation process to be configured, that is, a step flow for the operation process candidate, an influence evaluation table 32 indicating information for evaluating the operation process candidate, and a transition probability table 33. These will be described in detail later. The data may be received from the input device 4 or may be received, via the communication device 6, from a user terminal connected via a network. The data 31 to 33 may be stored in the storage device 3 or may be stored in a data server to which the operation process search device 10 can be connected via a network, and an address for accessing the data server may be stored in the storage device 3.

The risk evaluation unit 20 is a functional unit that calculates a risk score for each operation process candidate. The risk evaluation unit 20 includes a disadvantage level calculation unit 21, a likelihood calculation unit 22, and a risk score calculation unit 23 as sub-functional units. These will be described in detail later.

The display unit 12 is a functional unit that presents the operation process candidate to the user together with a risk score calculated by the risk evaluation unit 20. The user selects any one operation process candidate based on the risk score. Accordingly, it is possible to select an operation process in consideration of a risk caused by inference incorrectness of AI. The presentation to the user may be performed from the output device 5 or may be performed from the communication device 6 to a user terminal connected via a network.

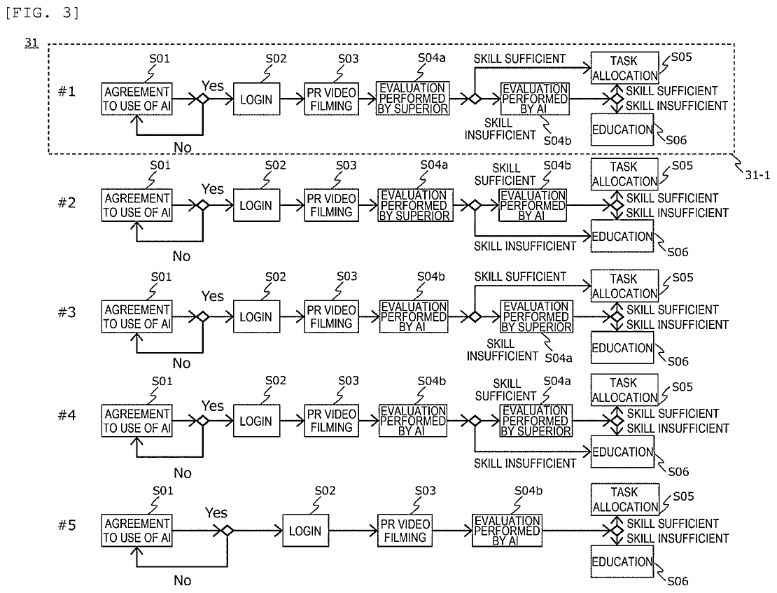

FIG. 3 shows operation process candidates input by the user as the operation process candidate data 31. The operation process candidate data 31 may have any data format as long as the operation process candidate data 31 can specify steps included in the operation process candidate and a route that can be taken in the operation process candidate. Here, it is assumed that the user inputs five operation process candidates (#1 to #5).

A content of an operation process of a first operation process candidate 31-1 will be described. First, consent to use of AI is obtained from a candidate (S01). When the candidate does not agree, an evaluation performed by AI is not performed. The candidate who has agreed to the use of the AI logs into an application system (S02), and shoots a PR video indicating that the candidate has a skill sufficient for a task being applied for (S03). Thereafter, the PR video is evaluated by a superior (evaluation manager) (S04a). When the superior determines that the skill is sufficient, the task is assigned to the candidate (S05). Meanwhile, when the superior determines that the skill is insufficient, the PR video is evaluated by the AI (S04b). When the AI determines that the skill is sufficient, the task is assigned to the candidate (S05). When both the superior and the AI determine that the skill is insufficient, an education that improves the skill is performed (S06).

A second operation process candidate to a fourth operation process candidate have steps the same as those of the first operation process candidate, but are different in an order of the evaluation (S04a) performed by the superior and the evaluation (S04b) performed by the AI or a step after the skill determination. A fifth operation process candidate does not include the evaluation (S04a) performed by the superior. The fifth operation process candidate and the first operation process candidate to the fourth operation process candidate which have the same steps have different risks of inference incorrectness occurring in the AI. Therefore, the operation process search device 10 visualizes and presents the risk of each operation process candidate by a risk score.

The influence evaluation table 32 and the transition probability table 33 are basic information for evaluating a risk of an operation process candidate.

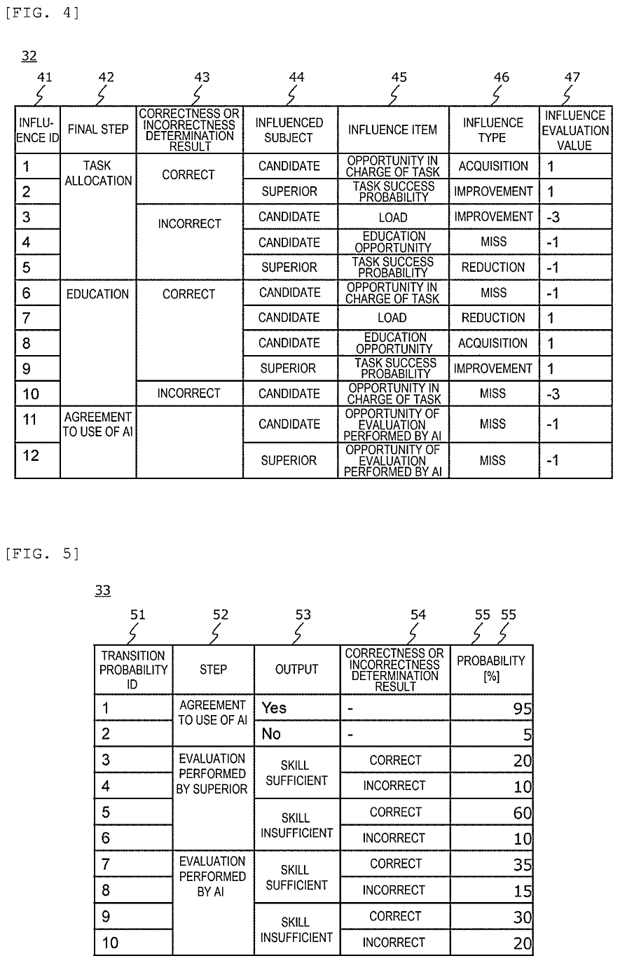

The influence evaluation table 32 is a list in which influence of a conclusion of the operation process on a related person is scored. FIG. 4 shows an example of the influence evaluation table applied to the operation process candidates in FIG. 3. Here, the conclusion of the operation process indicates a content of a final step of the operation process. In the example in FIG. 3, steps that can be the final steps are the agreement to the use of the AI (S01), the task allocation (S05), and the education (S06). Further, the steps that can be the final steps are divided into a step that includes correctness and incorrectness and a step that does not include correctness and incorrectness. In a risk evaluation according to the present embodiment, when the final step is the step that includes correctness and incorrectness, the risk evaluation is performed by dividing the correctness and the incorrectness. This is because, in general, an advantage and a disadvantage when a conclusion is correct in an operation process are asymmetric with an advantage and a disadvantage when the conclusion is incorrect in the operation process. Here, the agreement (disagreement) to the use of the AI is the step that does not include correctness and incorrectness, and the task assignment and the education are the steps that include correctness and incorrectness. Specifically, when the task allocation step and the education step are correct, it means that a task is allocated to a candidate whose skill is sufficient and a skill education is performed to a candidate whose skill is insufficient. Meanwhile, when the task allocation step and the education step are incorrect, it means that a task is allocated to a candidate whose skill is insufficient, and a skill education is performed to a candidate whose skill is sufficient.

A content of influence of a conclusion of an operation process on a related person and an evaluation value are determined by a user after considering how the conclusion (referred to as a conclusion including correctness and incorrectness when there is the correctness and the incorrectness) of the operation process influences the related person.

An influence ID 41 is an ID uniquely identifying influence of a conclusion of an operation process extracted by a user on a related person. A combination of a final step 42 and a correctness or incorrectness determination result 43 indicates the conclusion of the operation process. In this example, there are five possible conclusions of the operation process, which are task allocation (correct/incorrect), education (correct/incorrect), and agreement to the use of the AI. An influenced subject 44 is a subject to be influenced, and is determined according to a content of the operation process. In this example, the influenced subject is a candidate or a superior. An influence item 45 and an influence type 46 indicate contents of the influence on the influenced subject. An influence evaluation value 47 indicates an evaluation value obtained by scoring the influence. The influence evaluation value 47 is a positive value or a negative value. When the influence is positive for the influenced subject, the value is positive, and when the influence is negative for the influenced subject, the value is negative.

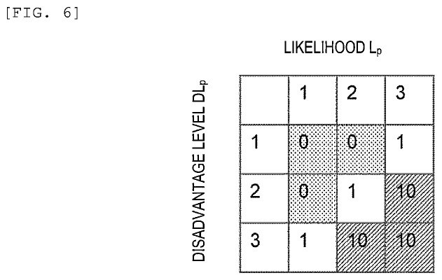

The transition probability table 33 is a list showing a transition probability when a route branches according to an output of a step in an operation process. FIG. 5 shows an example of the transition probability table applied to the operation process candidates in FIG. 3. In the example in FIG. 3, steps in which branching occurs according to outputs are the agreement to the use of the AI (S01), the evaluation performed by the superior (S04a), and the evaluation performed by the AI (S04b). Further, the outputs of the steps are divided into an output that includes correctness and incorrectness and an output that does not include correctness and incorrectness. In the risk evaluation according to the present embodiment, when the output of the step includes correctness and incorrectness, the risk evaluation is performed by dividing the correctness and the incorrectness. Here, the agreement/disagreement to the use of the AI is an output that does not include correctness and incorrectness, and the evaluation (skill sufficient/skill insufficient) performed by the superior and the evaluation (skill sufficient/skill insufficient) performed by the AI are outputs that include correctness and incorrectness. Specifically, when the output of the evaluation performed by the superior and the output of the evaluation performed by the AI are correct, it means that the candidate whose skill is sufficient is evaluated as having a sufficient skill, and the candidate whose skill is insufficient is evaluated as having an insufficient skill. In contrast, when the output of the evaluation performed by the superior and the output of the evaluation performed by the AI are incorrect, it means that the candidate whose skill is sufficient is evaluated as having an insufficient skill, and the candidate whose skill is insufficient is evaluated as having a sufficient skill.

A transition probability of a branch (referred to as a branch including correctness and incorrectness when there is the correctness and the incorrectness) is determined by the user. A transition probability ID 51 is an ID uniquely identifying a branch that may occur in an operation process. A transition probability is set for each combination of a step 52, an output 53, and a correctness or incorrectness determination result 54. In this example, there are ten situations, which are the agreement to the use of the AI (Yes/No), the evaluation “skill sufficient” performed by the superior (correct/incorrect), the evaluation “skill insufficient” performed by the superior (correct/incorrect), the evaluation “skill sufficient” performed by the AI (correct/incorrect), and the evaluation “skill insufficient” performed by the AI (correct/incorrect). A probability 55 indicates a transition probability for each branch, and the transition probability is set to 100% for each step.

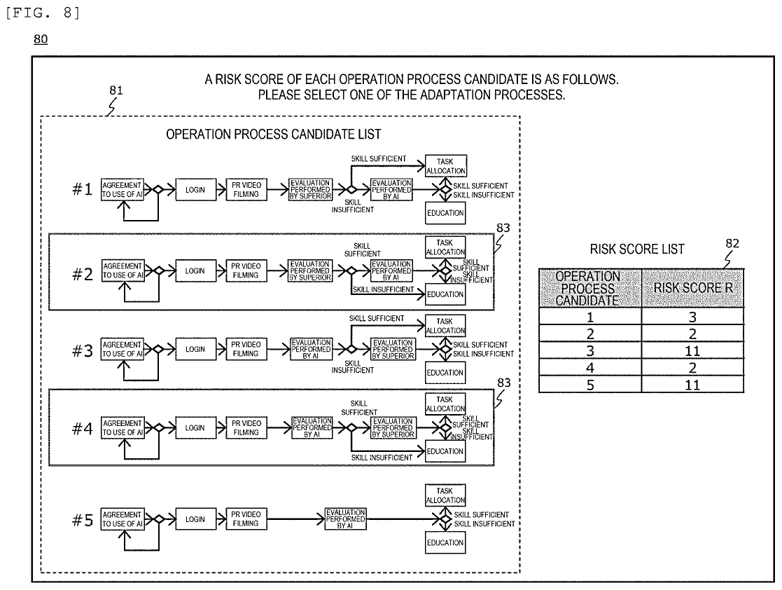

The risk evaluation unit 20 calculates a risk score for each operation process candidate using the above data. FIG. 7 shows a risk score calculation process for the operation process candidates (a part) shown in FIG. 3. The risk score is calculated for each route included in the operation process candidate. Here, the route refers to a route from the first step (in where, the agreement to the use of the AI) to the conclusion. As described above, when the conclusion of the operation process is correct or incorrect, a correct conclusion and an incorrect conclusion are treated as different conclusions. Therefore, when the final step includes correctness and incorrectness, a route leading to the correct conclusion and a route leading to the incorrect conclusion are treated as different routes although step flows of the routes are the same.

A route ID 61 is an ID uniquely identifying a route. In order to facilitate understanding, the ID is in an “X-Y” format, where X indicates routes whose step flows are the same, and Y indicates a difference in conclusions. For example, a route ID 1-1 and a route ID 1-2 indicate that the route ID 1-1 and the route ID 1-2 have the same step flow 63, but have different conclusions of the operation process candidate each of which is indicated as a combination of a final step 64 and a correctness or incorrectness determination result 65. Here, an operation process candidate ID 62 indicates corresponding one of the first operation process candidate to the fifth operation process candidate shown in FIG. 3.

Hereinafter, processing performed by the risk evaluation unit 20 will be described for each sub-functional unit with reference to FIG. 7.

The disadvantage level calculation unit 21 calculates an advantage score Aₚ68, a disadvantage score Dₚ69, and disadvantage level DLₚ 70 for each route. The advantage score Aₚ and the disadvantage score Dₚ are calculated based on the influence evaluation table 32 shown in FIG. 4. The advantage score Aₚ is calculated as a sum of influence evaluation values that are positive for conclusions of a route, and the disadvantage score Dₚ is calculated as a sum of absolute values of influence evaluation values which are negative for conclusions of the route. For example, in a case of a route 3-1, the advantage score Aₚ is calculated as 3 and the disadvantage score Dₚ is calculated as 1 with reference to the influence evaluation table (influence IDs 6 to 9) in a case in which the final step is the “education” and the correctness or incorrectness determination result is “correct”. Similarly, in a case of a route 3-2, the advantage score Aₚ is calculated as 0 and the disadvantage score Dₚ is calculated as 3 with reference to the influence evaluation table (influence ID 10) in a case in which the final step is the “education” and the correctness or incorrectness determination result is “incorrect”. The same applies to other routes.

The disadvantage level DLₚ is calculated based on the calculated advantage score Aₚ and the disadvantage score Dₚ. Here, an example of a case in which the disadvantage level DLₚ is calculated based on the disadvantage score Dₚ is shown as (Formula 1).

$${DL}_{p} = ⌈ 3 \times \frac{{D}_{p}}{max ( {D}_{p} )} ⌉ \qquad [ Math 1 ]$$

(Formula 1) is an example of a formula for dividing magnitude of the disadvantage score Dₚ into three levels. The formula is different depending on the number of levels. A maximum value (max (Dₚ)) of the disadvantage score Dₚ is obtained for each operation process candidate. Since the maximum value of the disadvantage score Dₚ in the first operation process candidate is 5, the disadvantage level DLₚ in the route 3-1 is calculated as 1, and the disadvantage level DLₚ in the route 3-2 is calculated as 2.

The likelihood calculation unit 22 calculates an occurrence probability Pₚ 66 and a likelihood Lₚ 67 for each route. The occurrence probability Pₚ of a route is calculated based on the transition probability table 33 shown in FIG. 5. For each route, the transition probability may be multiplied whenever a branch occurs along the step flow 63.

The likelihood Lₚ is calculated based on the calculated occurrence probability Pₚ. An example of a calculation formula is shown as (Formula 2).

$${L}_{p} = ⌈ 3 \times \sqrt{\frac{{P}_{p}}{100}} ⌉ \qquad [ Math 2 ]$$

(Formula 2) is an example of a formula for dividing magnitude of the occurrence probability Pₚ into three levels. The formula is different depending on the number of levels.

The risk score calculation unit 23 calculates a risk score Rₚ for each route and a risk score R for each operation process candidate. The risk score Rₚ for each route is calculated based on the disadvantage level DLₚ and the likelihood Lₚ for each route. An example of a calculation formula is shown as (Formula 3).

$${R}_{p} = \{ \begin{matrix}0 if ( {DL}_{p} + {L}_{p} ) \leq 3 \\ 1 if 3 < ( {DL}_{p} + {L}_{p} ) \leq 4 \\ 10 if 4 < ( {DL}_{p} + {L}_{p} ) \leq 6\end{matrix} \qquad [ Math 3 ]$$

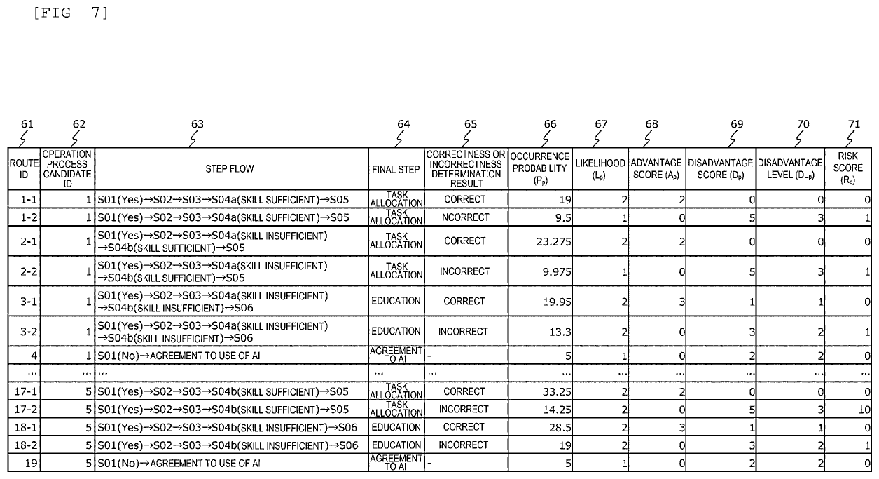

(Formula 3) expresses a risk score calculation method shown in FIG. 6 as a calculation formula. That is, when a sum of the disadvantage level DLₚ and the likelihood Lₚ for each route is 3 or less, the risk score Rₚ for each route is 0. When the sum of the disadvantage level DLₚ and the likelihood Lₚ for each route is greater than 3 and 4 or less, the risk score Rₚ for each route is 1. When the sum of the disadvantage level DLₚ and the likelihood Lₚ for each route is greater than 4 and 6 or less, the risk score Rₚ for each route is 10. A value of the risk score Rₚ for each segmented range or a segment can be set to any value by the user.

In the calculation example in FIG. 7, the risk score Rₚ for each route is calculated based on (Formula 3). Alternatively, for example, the risk score Rₚ for each route can also be calculated using a calculation formula such as (Formula 4).

$${R}_{p} = ⌈ exp ( \frac{2 \times {DL}_{p} + {L}_{p}}{{DL}_{p} + {L}_{p}} ) ⌉ \qquad [ Math 4 ]$$

The risk score R for each operation process candidate is calculated as a sum of the risk scores Rₚ for routes which are calculated for the operation process candidate. For example, since the risk score R of the first operation process candidate is a sum of the risk scores Rₚ of the routes 1-1 to 4 in FIG. 7, the risk score R is 3.

The risk evaluation unit 20 calculates the risk score R for each operation process candidate by the above processing.

FIG. 8 is an example of an operation process candidate evaluation screen 80 displayed by the display unit 12. The operation process candidates shown in FIG. 3 are displayed in an operation process candidate display field 81. The risk score R of each operation process candidate calculated by the risk evaluation unit 20 is displayed in an evaluation result list 82. For example, it is desirable to perform a highlighted display 83 for an operation process candidate that is highly evaluated in terms of the risk score R. In this example, the second operation process candidate and the fourth operation process candidate were highly evaluated (low risk).

Hereinafter, a modification of a risk evaluation method using the risk evaluation unit 20 will be described.

### (Modification 1)

It is considered that when an introduction of AI changes an evaluation process and an advantage obtained in an operation process before the introduction of the AI is no longer obtained after the introduction of the AI, a related person feels that not obtaining the advantage is a disadvantage. In Modification 1, the advantage that was not obtained due to the introduction of the AI is reflected in a disadvantage score. Modification 1 will be described based on the example in FIG. 3.

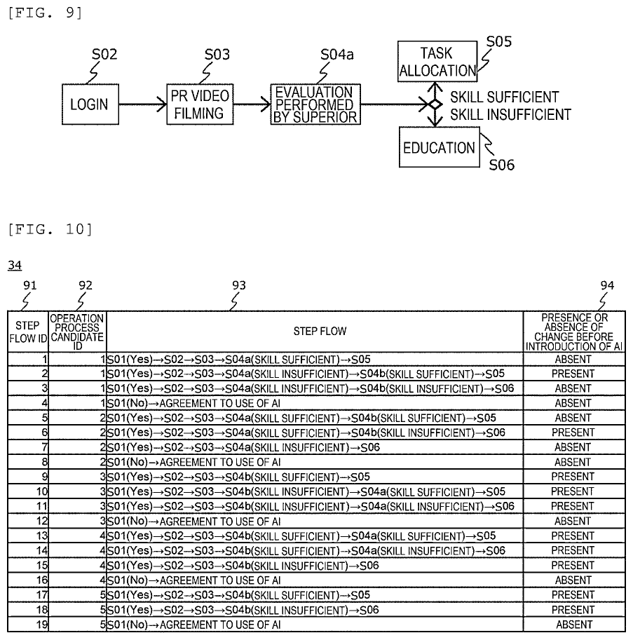

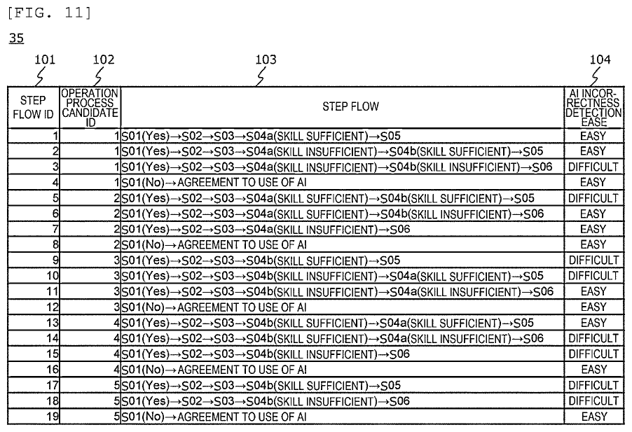

FIG. 9 is an operation process before introduction of AI. The same steps as those in FIG. 3 are denoted by the same reference signs. FIG. 10 shows a change list 34 indicating presence or absence of a change caused by introduction of AI for each step flow. The change list 34 is one piece of the operation process information input by the user, and is stored in the data storage unit 30. A step flow ID 91 is an ID uniquely identifying a step flow 93. A presence or absence of change before introduction of AI 94 indicates presence or absence of a change compared with an operation process before the introduction of the AI for each step flow. For example, in a step flow ID 2, even though the evaluation performed by the superior (S04a) shows that a skill is insufficient, the task allocation (S05) is implemented, which represents presence of a change accompanying introduction of AI. In the modification, in this case, a disadvantage score Dₚ′ of a route ID 2-2 (correctness or incorrectness determination result: incorrect) corresponding to the step flow ID 2 is a sum (Dₚ+Aₚ) of a disadvantage score Dₚ of an original route ID 2-2 and an advantage score Aₚ of a route ID 2-1 (correctness or incorrectness determination result: correct). That is, in the example in FIG. 7, the disadvantage score Dₚ′ of the route ID 2-1 is 0, and the disadvantage score Dₚ′ of the route ID 2-2 is 7. The disadvantage level DLₚ can be calculated by (Formula 5) in which the disadvantage score Dₚ of (Formula 1) in Embodiment 1 is substituted with the disadvantage score Dₚ′ in Modification 1.

$${DL}_{p} = ⌈ 3 \times \frac{{D}_{p}^{′}}{max ( {D}_{p}^{′} )} ⌉ \qquad [ Math 5 ]$$

### (Modification 2)

Modification 2 reflects ease of detecting incorrectness of an inference result of AI to the likelihood Lₚ for each route. Modification 2 will be described based on the example in FIG. 3.

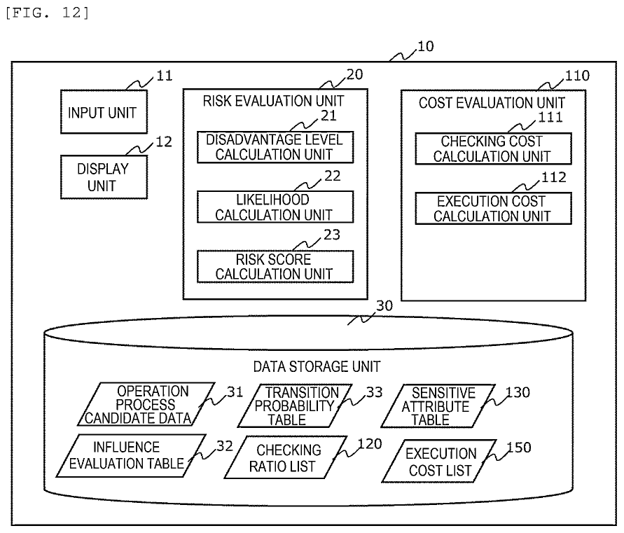

It is difficult to detect incorrectness of an inference result of AI in an operation process candidate not including an evaluation performed by a superior. Even in an operation process candidate including the evaluation performed by the superior, it is difficult to detect the incorrectness depending on an order of an evaluation performed by a person and an evaluation performed by AI. Specifically, in a case in which the order is the evaluation performed by the superior and followed by the evaluation performed by the AI, it is difficult to detect the incorrectness of the inference result of the AI when the evaluations are the same. Conversely, in a case in which the order is the evaluation performed by the AI and followed by the evaluation performed by the superior, it is difficult to detect the incorrectness of the inference result of the AI when the evaluations are different. Based on the above concept, FIG. 11 shows an ease evaluation list 35 in which the AI incorrectness detection ease is evaluated for each step flow. The ease evaluation list 35 is one piece of the operation process information input by the user, and is stored in the data storage unit 30. A step flow ID 101 is an ID uniquely identifying a step flow 103. An AI incorrectness detection ease 104 indicates ease of detecting incorrectness of an inference result of AI which is evaluated based on the above criterion for each step flow.

In Modification 2, the likelihood Lₚ for each route is calculated based on a calculation formula reflecting the ease of detecting the incorrectness of the inference result of the AI. An example of the calculation formula is shown as (Formula 6).

$${L}_{p} = ⌈ 3 \times \sqrt{\frac{{P}_{p}}{100} \times e} ⌉ \qquad [ Math 6 ]$$

Here, e is an easy score, and an occurrence probability of a route is corrected based on the easy score. Specifically, when it is easy to detect the incorrectness of the inference result of the AI, e=0.5, and when it is difficult to detect the incorrectness of the inference result of the AI, e=1. Accordingly, the likelihood Lₚ is calculated.

### Embodiment 2

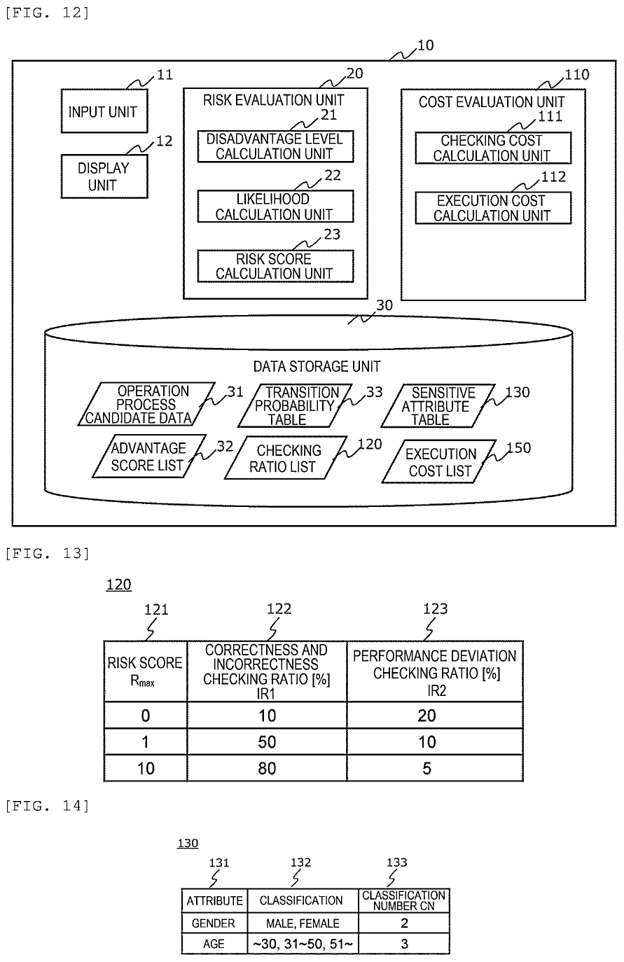

FIG. 12 is a functional block diagram of an operation process search device 10 according to Embodiment 2. Components common to those of the operation process search device 10 according to Embodiment 1 are denoted by the same reference signs, and redundant description thereof is omitted. Although details will be described later, the operation process search device 10 according to Embodiment 2 includes a cost evaluation unit 110 as an additional functional unit in addition to the functional units in Embodiment 1. The cost evaluation unit 110 includes a checking cost calculation unit 111 and an execution cost calculation unit 112 which are sub-functional units. A checking ratio list 120, a sensitive attribute table 130, and an execution cost list 150 are stored in the data storage unit 30 in addition to the operation process information in Embodiment 1. These will be described in detail later. It is possible to select an operation process using the operation process search device 10 according to Embodiment 2 in consideration of a cost incurred in an operation of the operation process. The cost incurred in the operation of the operation process includes a checking cost and an execution cost. A hardware structure of the operation process search device 10 according to Embodiment 2 is the same as that in Embodiment 1.

### (Checking Cost)

In an operation process into which AI is introduced, it is necessary to continue to check whether a correct result is obtained for a conclusion of the operation process. Further, it is necessary to check the conclusion of the operation process from a viewpoint of AI logic as well. Therefore, the checking cost calculation unit 111 visualizes a cost for checking the conclusion of the operation process (hereinafter, referred to as the checking cost). In order to reduce a checking cost C1, rather than checking all cases, a checking ratio, which is a ratio of checking, is determined in conjunction with the risk score.

FIG. 13 shows the checking ratio list 120. A checking ratio is set according to a risk score 121. Here, the risk score R shown in FIG. 6 is used and has three levels of values. A reason why Rₘₐₓ is expressed is that, as will be described later, the checking cost is first calculated for each step flow of an operation process candidate, and thus when the step flow includes a plurality of routes (that is, a conclusion includes correctness or incorrectness), the checking ratio is set to a maximum value among the risk scores Rₚ of the plurality of routes of the same step flow. The correctness and incorrectness checking ratio (IR1) 122 indicates a ratio at which the correctness and incorrectness checking is performed. In the example in FIG. 3, the correctness and incorrectness checking indicates checking whether a task is assigned according to a skill. As the risk score increases, the influence of the incorrectness of the conclusion increases, and thus the correctness and incorrectness checking ratio IR1 is set large according to the risk score. A performance deviation checking ratio (IR2) 123 indicates a ratio at which performance deviation checking is performed. In the example in FIG. 3, the performance deviation checking refers to checking whether assignment of a task is deviated from the viewpoint of the AI logic. Since an operation process candidate having a low risk score is more likely to be adopted, the performance deviation checking ratio IR2 is set small according to the risk score.

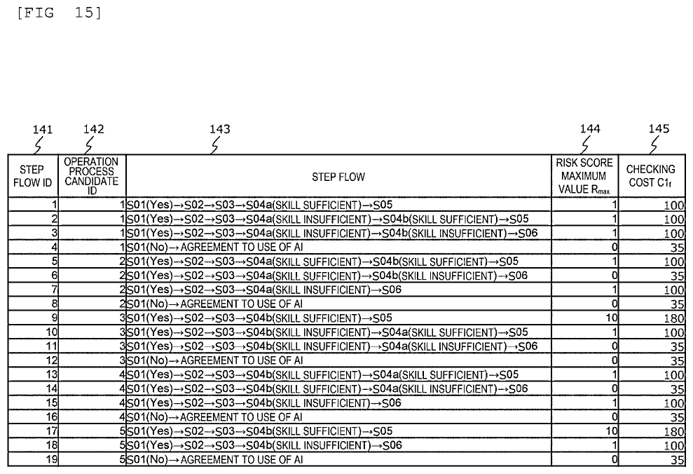

FIG. 14 shows an example of the sensitive attribute table 130 for performing performance deviation checking. From the viewpoint of the AI logic, it is not desirable that a deviation occurs in an attribute of a candidate who is assigned in a conclusion of an operation process. Therefore, an attribute (sensitive attribute) in which a deviation is particularly not desirable to occur is registered in advance as a sensitive attribute table, and it is checked whether a deviation that cannot be described occurs in the conclusion of the operation process. An attribute 131 indicates a sensitive attribute to be checked. A classification 132 indicates classification for checking a deviation of the sensitive attribute. A classification number 133 indicates a classification number CN in the classification 132. Here, an example is shown in which gender and age are treated as sensitive attributes.

A checking cost Cl_{f} is calculated for each step flow of the operation process candidate based on the above operation process information. An example of a calculation formula is shown in (Formula 7).

$$C {1}_{f} = IR 1 + 100 \times \frac{\sum CN}{IR 2} \qquad [ Math 7 ]$$

FIG. 15 shows a calculation example of the checking cost Cl_{f} for each step flow with reference to the example shown in FIG. 7. For example, in a step flow ID 1, the risk score maximum value Rₘₐₓ is 1 by comparing the risk score Rₚ of the route 1-1 with the risk score Rₚ of the route 1-2 (see FIG. 7). The checking cost Cl_{f} is calculated as 100 by substituting, into (Formula 7), the correctness and incorrectness checking ratio IR1 (50 in this case), the performance deviation checking ratio IR2 (10 in this case), and a sum (5) of the classification number CN when the risk score is 1.

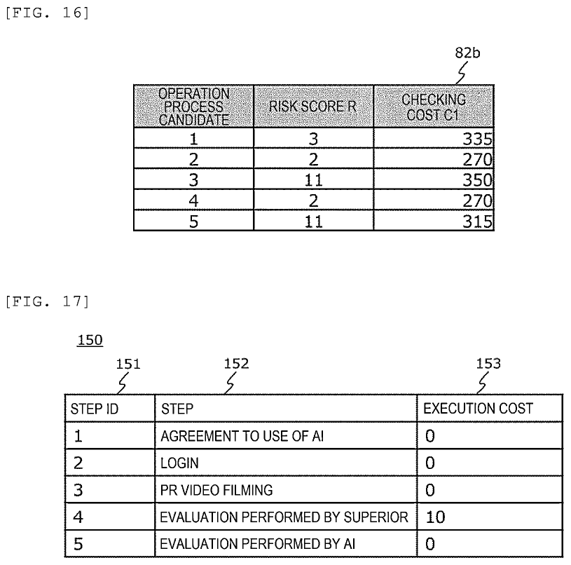

Thereafter, a sum of the checking costs Cl_{f} of the step flows included in the operation process candidate is calculated as the checking cost C1 of the operation process candidate. The result is displayed on the operation process candidate evaluation screen 80 displayed by the display unit 12 (see FIG. 8). FIG. 16 shows an evaluation result list 82b in Embodiment 2. In addition to the risk score R of each operation process candidate calculated by the risk evaluation unit 20, the checking cost C1 of each operation process candidate calculated by the cost evaluation unit 110 is displayed.

### (Execution Cost)

The execution cost calculation unit 112 visualizes a cost required for executing an operation process (hereinafter, referred to as an execution cost).

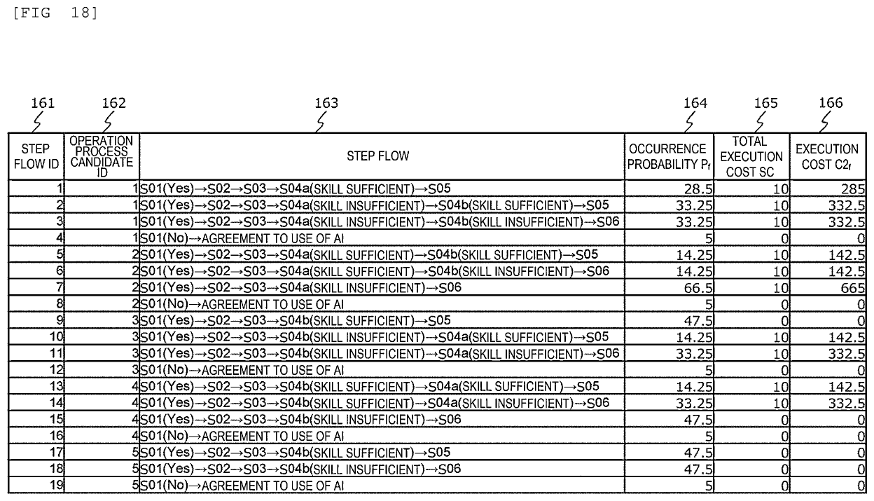

FIG. 17 shows the execution cost list 150. The execution cost is set for each step included in an operation process candidate. A step ID 151 is an ID uniquely identifying a step. An execution cost 153 is set for each step 152.

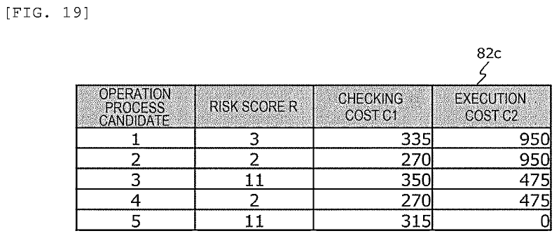

An execution cost C2_{f} for each step flow in the operation process candidate is calculated based on the execution cost for each step. The execution cost C2_{f} of a step flow is obtained as a product (C2_{f}=P_{f}×SC) of an execution cost (referred to as a total execution cost SC) of the step flow and an occurrence probability P_{f} of the step flow. FIG. 18 shows a calculation example of the execution cost C2_{f} for each step flow with reference to the example shown in FIG. 7. For example, the occurrence probability P_{f} of the step flow ID 1 is obtained as a sum (in where, 28.5) of the occurrence probability Pₚ of the route 1-1 and the occurrence probability Pₚ of the route 1-2 (see FIG. 7). Since the total execution cost SC of the step flow ID 1 includes a step ID 4 (evaluation performed by a superior), the total execution cost SC is 10. Therefore, the execution cost C2_{f} of the step flow ID 1 is 285.

Thereafter, a sum of the execution costs C2_{f} of the step flows included in the operation process candidate is calculated as an execution cost C2 of the operation process candidate. The result is displayed on the operation process candidate evaluation screen 80 displayed by the display unit 12 (see FIG. 8). FIG. 19 shows an evaluation result list 82c in Embodiment 2. In addition to the risk score R of each operation process candidate calculated by the risk evaluation unit 20, the checking cost C1 and the execution cost C2 of each operation process candidate calculated by the cost evaluation unit 110 are displayed. The user can select an operation process candidate to be used in consideration of the risk evaluation and the cost evaluation.

The invention is not limited to the above embodiments, and includes various modifications. For example, the above embodiments have been described in detail in order to facilitate understanding of the invention, and are not necessarily limited to those including all the configurations described above. A part of a configuration according to an embodiment can be replaced with a configuration according to another embodiment, and a configuration according to an embodiment can be added to a configuration according to another embodiment. A configuration can be added to, deleted from, or replaced with a part of a configuration of each embodiment.

### REFERENCE SIGNS LIST

1: processor (CPU)
2: memory
3: storage device
4: input device
5: output device
6: communication device
7: bus
10: operation process search device
11: input unit
12: display unit
20: risk evaluation unit
21: disadvantage level calculation unit
22: likelihood calculation unit
23: risk score calculation unit
30: data storage unit
31: operation process candidate data
32: influence evaluation table
33: transition probability table
34: change list
35: ease evaluation list
80: operation process candidate evaluation screen
81: operation process candidate display field
82, 82b, 82c: evaluation result list
110: cost evaluation unit
111: checking cost calculation unit
112: execution cost calculation unit
120: checking ratio list
130: sensitive attribute table
150: execution cost list

1. An operation process search device comprising:
a memory; and
a processor configured to function as a functional unit by executing a program loaded in the memory, wherein
an input unit, a risk evaluation unit, and a display unit are provided as the functional unit,
the input unit receives an input of data of a plurality of operation process candidates from a user and stores the data in a data storage unit, and the data of the operation process candidates includes a step flow including a step of performing an inference by artificial intelligence, an influence evaluation table in which influence of a conclusion of an operation process, which is a content of a final step of the operation process candidate, on a related person and an influence evaluation value are registered, and a transition probability table in which a transition probability of a branch included in the step flow is registered,
the risk evaluation unit calculates, for each route leading to a conclusion that is to be taken by the operation process candidate, a risk score based on an occurrence probability of the route and a disadvantage score that is calculated based on a negative value of the influence evaluation value of the influence generated in the route, and calculates, as a risk score of the operation process candidate, a sum of the risk scores calculated for a plurality of the routes that is to be taken by the operation process candidate, and
the display unit displays, to the user, the step flows of the plurality of operation process candidates and the risk scores of the operation process candidates calculated by the risk evaluation unit.

2. The operation process search device according to claim 1, wherein
the data of the operation process candidates includes a change list in which presence or absence of a change is determined by comparing a step flow of the operation process candidate with a step flow of an operation process that does not include a step of performing an inference by artificial intelligence, and
the risk evaluation unit calculates the disadvantage score of a first route leading to an incorrect conclusion as a sum of a negative value of the influence evaluation value of the influence generated in the first route and a positive value of the influence evaluation value of the influence generated in a second route leading to a correct conclusion in a step flow the same as the first route.

3. The operation process search device according to claim 1, wherein
the data of the operation process candidates includes an ease evaluation list in which ease of detecting incorrectness of an inference performed by artificial intelligence in the step flow of the operation process candidate is determined, and
the risk evaluation unit calculates a risk score for each route based on a corrected occurrence probability obtained by correcting, based on the determination of the ease evaluation list, the occurrence probability of the route leading to the conclusion that is to be taken by the operation process candidate.

4. The operation process search device according to claim 1, further comprising:
a cost evaluation unit as the functional unit, wherein
the data of the operation process candidates includes a checking ratio list defining a checking ratio at which the conclusion of the operation process candidate is checked, and the checking ratio is determined according to a risk score of the step flow of the operation process candidate,
the cost evaluation unit calculates, for each step flow of the operation process candidate, a checking cost based on a checking ratio corresponding to the risk score of the step flow, and calculates, as a checking cost of the operation process candidate, a sum of the checking costs calculated for the step flows of the operation process candidate, and
the display unit displays, to the user, the step flows of the plurality of operation process candidates and the checking costs of the operation process candidates calculated by the cost evaluation unit.

5. The operation process search device according to claim 4, wherein
the checking ratio list defines a checking ratio for correctness and incorrectness checking of checking correctness and incorrectness of a conclusion of an operation process and a checking ratio for performance deviation checking of checking whether a deviated determination is made from a viewpoint of AI logic.

6. The operation process search device according to claim 1, further comprising:
a cost evaluation unit as the functional unit, wherein
the data of the operation process candidates includes an execution cost list indicating an execution cost for each step included in the operation process candidate,
the cost evaluation unit calculates, for each step flow of the operation process candidate, an execution cost based on an occurrence probability of the step flow and a total execution cost of the step flow calculated based on the execution cost list, and calculates, as an execution cost of the operation process candidate, a sum of the execution costs calculated for the step flows of the operation process candidate, and
the display unit displays, to the user, the step flows of the plurality of operation process candidates and the execution costs of the operation process candidates calculated by the cost evaluation unit.

7. An operation process search method using an operation process search device including: a memory; and a processor configured to function as a functional unit by executing a program loaded in the memory, wherein
an input unit, a risk evaluation unit, and a display unit are provided as the functional unit,
the input unit receives an input of data of a plurality of operation process candidates from a user and stores the data in a data storage unit, and the data of the operation process candidates includes a step flow including a step of performing an inference by artificial intelligence, an influence evaluation table in which influence of a conclusion of an operation process, which is a content of a final step of the operation process candidate, on a related person and an influence evaluation value are registered, and a transition probability table in which a transition probability of a branch included in the step flow is registered,
the risk evaluation unit calculates, for each route leading to a conclusion that is to be taken by the operation process candidate, a risk score based on an occurrence probability of the route and a disadvantage score that is calculated based on a negative value of the influence evaluation value of the influence generated in the route, and calculates, as a risk score of the operation process candidate, a sum of the risk scores calculated for a plurality of the routes that is to be taken by the operation process candidate, and
the display unit displays, to the user, the step flows of the plurality of operation process candidates and the risk scores of the operation process candidates calculated by the risk evaluation unit.

8. The operation process search method according to claim 7, further comprising:
a cost evaluation unit as the functional unit, wherein the data of the operation process candidates includes a checking ratio list defining a checking ratio at which the conclusion of the operation process candidate is checked, and the checking ratio is determined according to a risk score of the step flow of the operation process candidate,
the cost evaluation unit calculates, for each step flow of the operation process candidate, a checking cost based on a checking ratio corresponding to the risk score of the step flow, and calculates, as a checking cost of the operation process candidate, a sum of the checking costs calculated for the step flows of the operation process candidate, and
the display unit displays, to the user, the step flows of the plurality of operation process candidates and the checking costs of the operation process candidates calculated by the cost evaluation unit.

9. The operation process search method according to claim 8, wherein
the checking ratio list defines a checking ratio for correctness and incorrectness checking of checking correctness and incorrectness of a conclusion of an operation process and a checking ratio for performance deviation checking of checking whether a deviated determination is made from a viewpoint of AI logic.

10. The operation process search method according to claim 7, wherein
a cost evaluation unit is provided as the functional unit,
the data of the operation process candidates includes an execution cost list indicating an execution cost for each step included in the operation process candidate,
the cost evaluation unit calculates, for each step flow of the operation process candidate, an execution cost based on an occurrence probability of the step flow and a total execution cost of the step flow calculated based on the execution cost list, and calculates, as an execution cost of the operation process candidate, a sum of the execution costs calculated for the step flows of the operation process candidate, and
the display unit displays, to the user, the step flows of the plurality of operation process candidates and the execution costs of the operation process candidates calculated by the cost evaluation unit.

11. An operation process program executed by an information processing device including a memory and a processor, wherein
the operation process search program functions as an input unit, a risk evaluation unit, and a display unit by being loaded into the memory and executed by the processor,
the input unit receives an input of data of a plurality of operation process candidates from a user and stores the data in a data storage unit, and the data of the operation process candidates includes a step flow including a step of performing an inference by artificial intelligence, an influence evaluation table in which influence of a conclusion of an operation process, which is a content of a final step of the operation process candidate, on a related person and an influence evaluation value are registered, and a transition probability table in which a transition probability of a branch included in the step flow is registered,
the risk evaluation unit calculates, for each route leading to a conclusion that is to be taken by the operation process candidate, a risk score based on an occurrence probability of the route and a disadvantage score that is calculated based on a negative value of the influence evaluation value of the influence generated in the route, and calculates, as a risk score of the operation process candidate, a sum of the risk scores calculated for a plurality of the routes that is to be taken by the operation process candidate, and
the display unit displays, to the user, the step flows of the plurality of operation process candidates and the risk scores of the operation process candidates calculated by the risk evaluation unit.

12. The operation process search program according to claim 11, wherein
the operation process search program functions as a cost evaluation unit by being loaded into the memory and executed by the processor,
the data of the operation process candidates includes a checking ratio list defining a checking ratio at which the conclusion of the operation process candidate is checked, and the checking ratio is determined according to a risk score of the step flow of the operation process candidate,
the cost evaluation unit calculates, for each step flow of the operation process candidate, a checking cost based on a checking ratio corresponding to the risk score of the step flow, and calculates, as a checking cost of the operation process candidate, a sum of the checking costs calculated for the step flows of the operation process candidate, and
the display unit displays, to the user, the step flows of the plurality of operation process candidates and the checking costs of the operation process candidates calculated by the cost evaluation unit.

13. The operation process search program according to claim 12, wherein
the checking ratio list defines a checking ratio for correctness and incorrectness checking of checking correctness and incorrectness of a conclusion of an operation process and a checking ratio for performance deviation checking of checking whether a deviated determination is made from a viewpoint of AI logic.

14. The operation process search program according to claim 11, wherein
the operation process search program functions as a cost evaluation unit by being loaded into the memory and executed by the processor,
the data of the operation process candidates includes an execution cost list indicating an execution cost for each step included in the operation process candidate,
the cost evaluation unit calculates, for each step flow of the operation process candidate, an execution cost based on an occurrence probability of the step flow and a total execution cost of the step flow calculated based on the execution cost list, and calculates, as an execution cost of the operation process candidate, a sum of the execution costs calculated for the step flows of the operation process candidate, and
the display unit displays, to the user, the step flows of the plurality of operation process candidates and the execution costs of the operation process candidates calculated by the cost evaluation unit.
